(19) United States
(12) Patent Application Publication
(10) Pub. No.: US 2015/0100496 A1
(43) Pub. Date: Apr. 9, 2015

(54) Switching System Able to Prevent Fraud from Falsified Digital Information

(71) Applicant: Castles Technology Co., Ltd, New Taipei (TW)

(72) Inventors: Hung-Chun Lin, Hsinchu (TW); Kai-Yu Cheng, Taipei (TW)

(73) Assignee: Castles Technology Co., Ltd, New Taipei (TW)

(21) Appl. No.: 14/049,299

(22) Filed: Oct. 9, 2013

(51) Int. Cl. G06Q 20/40; G06Q 30/02

(52) U.S. Cl. CPC G06Q 20/409; G06Q 30/0277
USPC 705/67

(57) ABSTRACT

The present invention is a switching system able to prevent fraud from falsified digital information, generally installed into card reader device, wherein the card reader device can read integrated circuit card. The switch system can provide safe financial transaction during advertisement broadcasting, and resume advertisement broadcasting after transaction. The transaction processor of the present invention turns off all the links with the card reader device except certain transaction center, stops broadcasting advertisement sent from advertisement center, and prevent falsified information from displaying on the monitor.

### BACKGROUND OF THE INVENTION

1. Field of the Invention

The present invention is related to a switching system able to prevent fraud from falsified digital information. The system uses an Integrated Circuits Card (ICC) reader and switch system for safe and secured financial trading activities.

2. Description of Related Art

The consumer market in the world changes day by day, especially after the financial crisis occurred in 2008. The consuming ability in Asia has grown drastically and the financial core of the world is now diverting together with the cash flow. High buying power is usually accompanied by the use of credit cards as it serves as a convenient means of cash flow especially for purchasing of goods with high prices, as cash transaction in such cases will be very inconvenient.

Electronic technology is more diversified as our technology progresses. Various electronic devices are normal in our daily lives now and serve as a very important medium for acquisition of information and communication. The use of card readers grow more popular as the use of credit cards in the Asian region grows. However, the convenience of credit cards comes with the offset of risk during trade activities, especially with the use of card readers, which is now the primary target of financial criminals. These criminals tend to manipulate the card readers or hack into the operating system in order to gain access of personal information for illegal profits.

Please refer to FIG. 1 for the block diagram of the card reader system. As depicted in FIG. 1, a card reader system comprises of a processor P11, a monitor P12, and multiple trading devices. Trading devices may include wireless transaction, Magstripe reader, code input, or smartcard transaction. The processor P11 connects to multiple devices and the monitor P12, and will connect to an advertisement center P2 and a trading center P3 at the same time. When the card reader is in the standby mode, the processor P11 will receive advertisements from the advertisement center P2 and will be displayed on the monitor P12. During transaction, the processor P11 will process information from multiple devices and send them to the trading center P3. At this time, the processor P11 pause the advertisement and display the information of the multiple transaction devices on monitor P12.

Aforementioned, the card reader is able to play advertisements during standby mode, but this feature also jeopardizes the safety of transactions. The Internet remains active when the processor P11 connects to the advertisement center P2 and advertisements delivered by the advertisement center is not encrypted and can therefore be hacked easily. When the card reader is activated for transaction, the hacker can display a fraud transaction message on the monitor P12 through the advertisement center P2 and prompt the user to engage in a fraud transaction. The user then therefore pays to the hacker's account without awareness.

In view of the aforementioned drawbacks of the conventional card reader, the inventor of the present invention based on years of practice experience in the related industry to conduct extensive researches and experiments, and finally developed a safety cover design for financial transaction device in accordance with the present invention to overcome the drawbacks of the prior art.

### SUMMARY OF THE INVENTION

Therefore, it is a primary objective of the invention to provide a switching system able to prevent fraud from falsified digital information, offering safety financial transaction with normal advertisement broadcasting. Especially the transaction processor can shut all links other than that from the trading center. Advertisement from the advertisement center can be paused to prevent falsified information from displaying on the monitor.

To achieve the aforementioned objective, the present invention provides a switching system able to prevent fraud from falsified digital information, comprising: a plurality of financial transaction devices, producing a transaction information; a monitor system, a transaction processor, connecting to a plurality of financial transaction devices, and receiving transaction information from the financial transaction devices; wherein the transaction information is encrypted and processed to form a security information; a dataflow valve, having at least one transaction flow and an advertisement flow, connecting to the financial transaction processor and the monitor system; wherein the advertisement flow is inactive when the transaction flow is active, and the advertisement flow is active when the transaction flow is inactive; wherein the transaction processor controls the dataflow valve and activates the transaction flow, so the transaction processor sends the security information to the monitor system via the transaction flow of the dataflow valve; a sub-processor, connecting to the advertisement center and trading center via internet, also connecting to the transaction processor; wherein the sub-processor processes an advertisement information sent from an advertisement center, and sends the advertisement information to monitor system via the advertisement flow of the dataflow valve; wherein the transaction processor receives the transaction information from the transaction devices, then inactivating the advertisement flow through the dataflow valve and activating the transaction flow, also, the sub-processor stop receiving the advertisement information sent from the advertisement center; the transaction processor sends the security information to the trading center via the sub-processor, so the sub-processor stops processing, but provides sending the security information; the trading processor confirms if a transaction success message is sent from the trading center; when the transaction success message is received from the trading center, the transaction processor send the transaction success message to the monitor system, when the transaction success message is received from the trading center, and prompts the sub-processor to initiate receiving the advertisement information from the advertisement center and activate advertisement flow.

The present invention also provides operating procedures to operate the switching system able to prevent fraud by falsified digital information, the operating procedures are as follow: (S11) sub-processor processes the advertisement information from the advertisement center and sends the advertisement information to the monitor system via the advertisement flow of the dataflow valve; (S12) transaction processor determine if the transaction information received is sent from the trading devices; If yes, proceed step S13, if no, proceed step S11; (S13) transaction processor receives the transaction information of the trading devices; (S14) transaction processor is encrypt the transaction processor information from trading center, then formed a security information; (S15) transaction processor inactivate the advertisement flow of the dataflow valve and activate the transaction flow; (S16) transaction processor prompts the sub-processor to stop receiving the advertisement information sent from the advertisement center; (S17) transaction processor send the security information to the trading center via the sub-processor; (S18) transaction processor receives the transaction success message from the trading center and sends to the monitor system to display the transaction success message; (S19) transaction processor prompts the sub-processor to receive the advertisement information sent from the advertisement center, and activates the advertisement flow.

### BRIEF DESCRIPTION OF THE DRAWINGS

FIG. 1 for the block diagram of the card reader system.

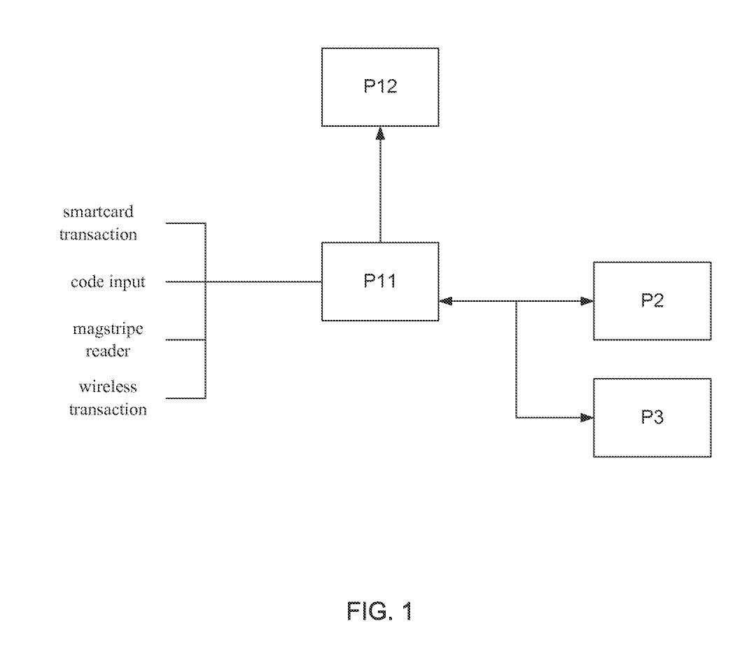

FIG. 2 depicts the block diagram of the switch system able to prevent fraud from falsified digital information.

FIG. 3 depicts one of the dataflow valves used in this invention.

FIG. 4 for the fraud prevention switching operating procedure of this invention.

FIG. 5 for the second application of this invention.

### DETAILED DESCRIPTION OF THE PREFERRED EMBODIMENTS

The technical contents and characteristics of the present invention will be apparent with the detailed description of a preferred embodiment accompanied with related drawings as follows. It is noteworthy that the drawings are provided for the purpose of illustrating the present invention, but not intended for limiting the scope of the invention.

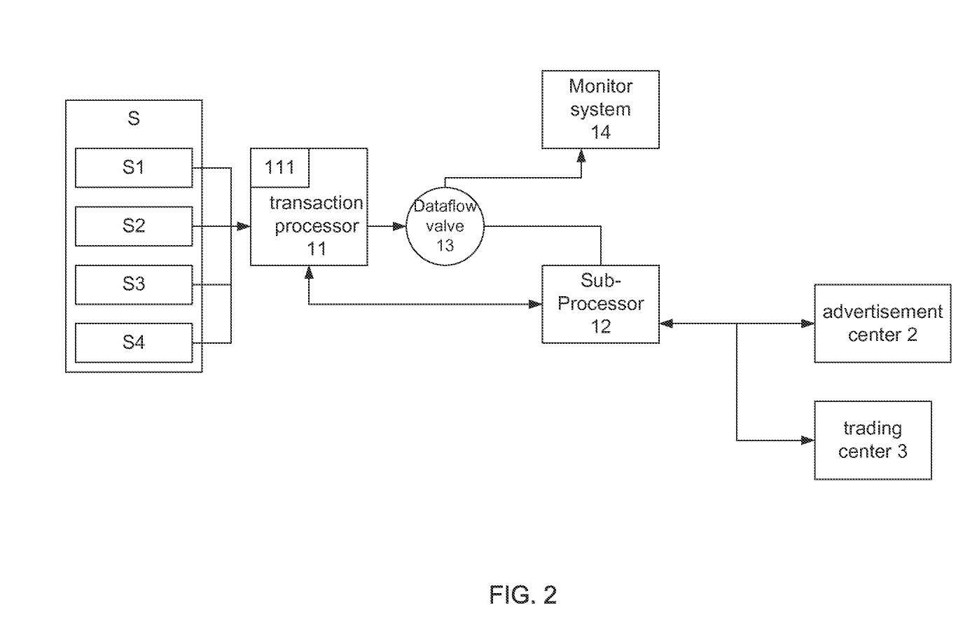

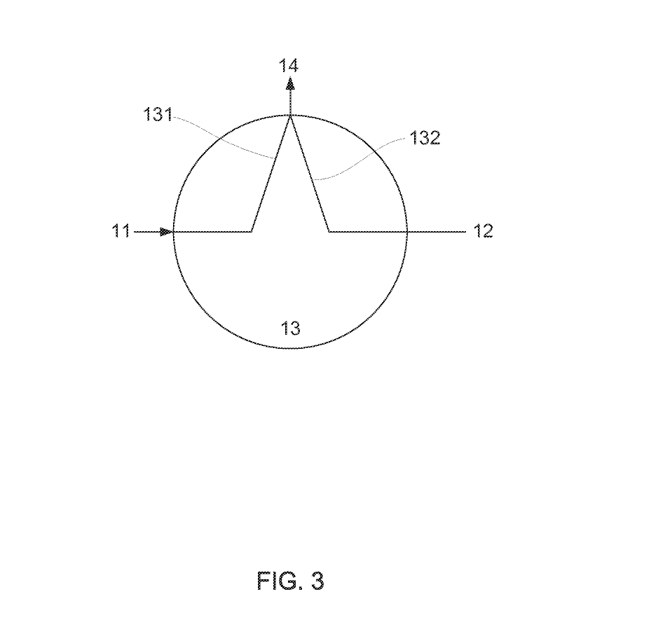

Please refer to FIG. 2 and FIG. 3. FIG. 2 depicts the block diagram of the switching system able to prevent fraud from falsified digital information, and FIG. 3 depicts one of the dataflow valves used in this invention. As depicted in FIG. 2, this invention is switching system able to prevent fraud by falsified digital information, being installed into card reader devices, and including: a plurality of financial transaction devices S, producing a transaction information; a monitor system 14, a transaction processor 11, connecting to a plurality of financial transaction devices S, and receiving transaction information from the financial transaction devices S; wherein the transaction information is encrypted and processed to form a security information; a dataflow valve 13, having at least one transaction flow 131 and an advertisement flow 132, connecting to the financial transaction processor 11 and the monitor system 14; wherein the advertisement flow 132 is inactive when the transaction flow 131 is active, and the advertisement flow 132 is active when the transaction flow 131 is inactive; wherein the transaction processor 11 controls the dataflow valve 13 and activates the transaction flow 131, so the transaction processor 11 sends the security information to the monitor system 14 via the transaction flow 131 of the dataflow valve 13; a sub-processor 12, connecting to the advertisement center 2 and trading center 3 via internet, also connecting to the transaction processor 11; wherein the sub-processor 12 processes an advertisement information sent from an advertisement center 2, and sends the advertisement information to monitor system 14 via the advertisement flow 132 of the dataflow valve 13; wherein the transaction processor 11 receives the transaction information from the transaction devices S, then inactivating the advertisement flow 132 through the dataflow valve 13 and activating the transaction flow 131, also, the sub-processor 12 stop receiving the advertisement information sent from the advertisement center 2; the transaction processor 11 sends the security information to the trading center 3 via the sub-processor 12, so the sub-processor 12 stops processing, but provides sending the security information; the trading processor 11 confirms if a transaction success message is sent from the trading center 3; when the transaction success message is received from the trading center 3, the transaction processor 11 send the transaction success message to the monitor system 14, when the transaction success message is received from the trading center 3, and prompts the sub-processor 12 to initiate receiving the advertisement information from the advertisement center 2 and activate advertisement flow 132. As monitor system 14 has no decoding function, the same symbol used for the encrypted transaction system, such as “*”, will be displayed to let the consumer know that the system has received the entered transaction information.

Advertisement center 2 can by any purchasing websites or online stores. When the system of the invention is in standby mode, the advertisement information sent from advertisement center 2 can be displayed on the monitor system 14. Trading center 3 may be banks or other financial institutes. This invention, allows connection to trading center, i.e., during transaction, to shut down connection with advertisement center 2 to prevent hacking of the system. This invention can connect to multiple advertisement centers 2 and multiple trading centers 3 simultaneously.

Please refer to FIG. 2: the financial transaction devices S may consists of an ICC card reader S1, a Magstripe reader device S2, ad password entering device S3 or wireless information reader S4. Transaction information will be generated when consumer engage in any of the aforementioned transaction activities. In this invention, there can be multiple trading devices S. Trading devices S can be any of the aforementioned, or combination of multiple modules.

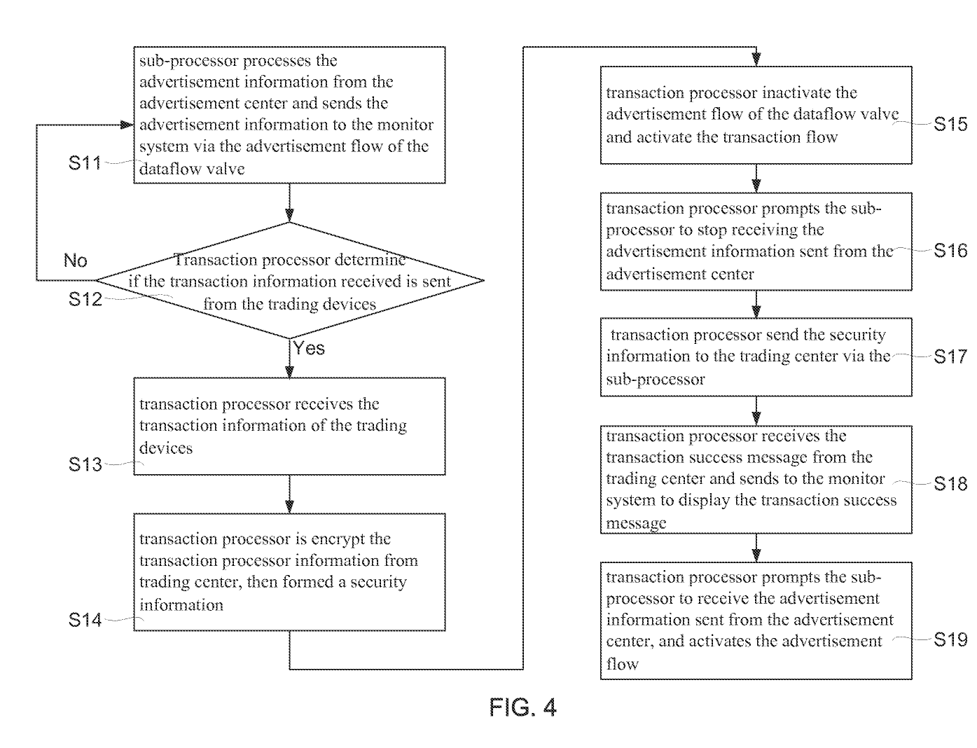

The first application of this invention will be described next. Please refer to FIG. 4 for the fraud prevention switching operating procedure of this invention. As depicted in FIG. 4, this invention is a switching system able to prevent fraud by falsified digital information, the operating procedures are as follow: (S11) sub-processor processes the advertisement information from the advertisement center and sends the advertisement information to the monitor system via the advertisement flow of the dataflow valve; (S12) transaction processor determine if the transaction information received is sent from the trading devices; If yes, proceed step S13, if no, proceed step S11; (S13) transaction processor receives the transaction information of the trading devices; (S14) transaction processor is encrypt the transaction processor information from trading center, then formed a security information; (S15) transaction processor inactivate the advertisement flow of the dataflow valve and activate the transaction flow; (S16) transaction processor prompts the sub-processor to stop receiving the advertisement information sent from the advertisement center; (S17) transaction processor send the security information to the trading center via the sub-processor; (S18) transaction processor receives the transaction success message from the trading center and sends to the monitor system to display the transaction success message; (S19) transaction processor prompts the sub-processor to receive the advertisement information sent from the advertisement center, and activates the advertisement flow.

The previous section describe the procedures of phase one. In order to ensure that data can be delivered via a safe route, the developer of the system has developed a safe mode. First of, the transaction processor 11 send a first verification message to trading center 3 prior to sending the security information. The first verification message is encrypted and can only be read by the trading center 3. The trading center 3 can reply a second verification message according to the first verification message, the trading processor 11 then activates the dataflow valve 13 for transaction flow 131 as well as stops receiving advertisement information sent from advertisement center 2, and sends the security information to the trading center 3. The trading center 3 replies a transaction success message to the transaction processor 11 when the transaction is completed. After the transaction has been completed, transaction processor 11 then reestablish the advertisement flow 132 of the dataflow valve 13 and resume receiving of advertisement information from advertisement center 2.

The transaction processor 11 contains a database 111, wherein the database 111 contains a plurality of address of trading centers and a plurality of first safety codes. The first safety code is designated for each address of trading center. The first verification message includes one address of trading center and one first safety code. The trading center 3 must confirms the first safety code before accessing the first verification message. The trading center 3 can also send a transaction request message stored first safety code.

As mentioned, the security information can only be sent when the pathway to the trading center 3 is confirmed safe. A number of things may occur when trading center 3 receives the information. For instance, the trading center 3 can send a reply to transaction processor 11 stating that the transaction is completed. Also, the trading center 3 can responds a second verification message to the transaction processor 11 when received the security information from the transaction processor 11. The transaction processor 11 sent the second verification message to the monitor system 14, and the second verification message is displayed on the monitor system 14, the transaction processor 11 then receives and processes the transaction information sent from the financial transaction device S, the transaction information is also encrypted and processed to form a security information. The security information then is sent to the trading center 3 via the sub-processor 12. The trading center 3 can reply a transaction success message to transaction processor 11 when the transaction is completed.

In addition, the ensure that the reading process of the security information is safe, the security information must contain a second verification code, and the trading center 3 must verify the second verification code prior to reading the security information when receiving security information.

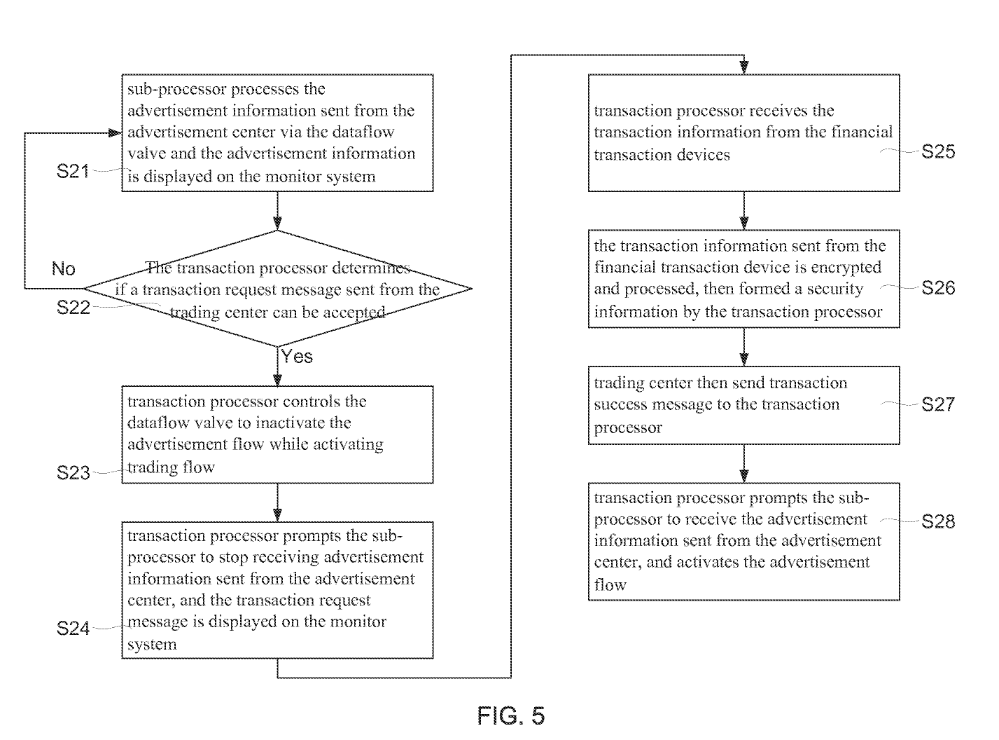

Please refer to FIG. 5 for the second application of this invention. The trading activity differs in may way and the trading center may ask for a transaction request in advance and the processing procedure will then be entirely different. Please compare FIGS. 2 and 5 for details. (S21) sub-processor processes the advertisement information sent from the advertisement center via the dataflow valve and the advertisement information is displayed on the monitor system. (S22) the transaction processor determines if a transaction request message sent from the trading center can be accepted. If yes, proceed step (23), if no, proceed step (21). (S23) transaction processor controls the dataflow valve to inactivate the advertisement flow while activating trading flow; (S24) transaction processor prompts the sub-processor to stop receiving advertisement information sent from the advertisement center, and the transaction request message is displayed on the monitor system; (S25) transaction processor receives the transaction information from the financial transaction devices; (26) the transaction information sent from the financial transaction device is encrypted and processed, then formed a security information by the transaction processor; (S27) trading center then send transaction success message to the transaction processor; (S28) transaction processor prompts the sub-processor to receive the advertisement information sent from the advertisement center, and activates the advertisement flow.

In the second application of the present invention, the transaction processor can determine if the transaction request from trading center 3 can be accepted. In another words, transaction processor 11 can determine if the transaction request was sent from trading center 3. If yes, the consumer can engage in the trading activity via trading devices S and the transaction information can be generated. In addition, to ensure that trading center 3 is safe, the transaction processor 11 verifies the address of the trading center stored in the database 111 and the first verification message with the transaction request message sent from the trading center 3. The transaction can only commence when trading center 3 is confirmed safe.

The structure of this invention has been clearly elaborated in the aforementioned content. In summary, it contains the following advantages:

(1) During transaction, the transaction processor of this invention can shut all links other than that from the trading center. Advertisement from the advertisement center can be paused to prevent falsified information from displaying on the monitor.

(2) The operating procedure of this invention has been carefully designed to ensure that the transaction information is safe without affecting the advertisement displaying function.

While the invention has been described by means of specific embodiments, numerous modifications and variations could be made thereto by those skilled in the art without departing from the scope and spirit of the invention set forth in the claims.

What is claimed is:

1. A switching system able to prevent fraud by falsified digital information, being installed into card reader devices, and including:
a plurality of financial transaction devices, producing a transaction information;
a monitor system,
a transaction processor, connecting to a plurality of financial transaction devices, and receiving transaction information from the financial transaction devices;
wherein the transaction information is encrypted and processed to form a security information;
a dataflow valve, having at least one transaction flow and an advertisement flow, connecting to the financial transaction processor and the monitor system; wherein the advertisement flow is inactive when the transaction flow is active, and the advertisement flow is active when the transaction flow is inactive; wherein the transaction processor controls the dataflow valve and activates the transaction flow, so the transaction processor sends the security information to the monitor system via the transaction flow of the dataflow valve;
a sub-processor, connecting to the advertisement center and trading center via internet, also connecting to the transaction processor; wherein the sub-processor processes an advertisement information sent from an advertisement center, and sends the advertisement information to monitor system via the advertisement flow of the dataflow valve; wherein the transaction processor receives the transaction information from the transaction devices, then inactivating the advertisement flow through the dataflow valve and activating the transaction flow, also, the sub-processor stop receiving the advertisement information sent from the advertisement center; the transaction processor sends the security information to the trading center via the sub-processor, so the sub-processor stops processing, but provides sending the security information; the trading processor confirms if a transaction success message is sent from the trading center; when the transaction success message is received from the trading center, the transaction processor send the transaction success message to the monitor system, when the transaction success message is received from the trading center, and prompts the sub-processor to initiate receiving the advertisement information from the advertisement center and activate advertisement flow.

2. The switching system able to prevent fraud by falsified digital information of claim 1, can be operated as follow:
(S11) sub-processor processes the advertisement information from the advertisement center and sends the advertisement information to the monitor system via the advertisement flow of the dataflow valve;
(S12) transaction processor determine if the transaction information received is sent from the trading devices; If yes, proceed step (S13), if no, proceed step (S11);
(S13) transaction processor receives the transaction information of the trading devices;
(S14) transaction processor is encrypt the transaction processor information from trading center, then formed a security information;
(S15) transaction processor inactivate the advertisement flow of the dataflow valve and activate the transaction flow;
(S16) transaction processor prompts the sub-processor to stop receiving the advertisement information sent from the advertisement center;
(S17) transaction processor send the security information to the trading center via the sub-processor;
(S18) transaction processor receives the transaction success message from the trading center and sends to the monitor system to display the transaction success message;
(S19) transaction processor prompts the sub-processor to receive the advertisement information sent from the advertisement center, and activates the advertisement flow.

3. The switching system able to prevent fraud by falsified digital information of claim 1, wherein the transaction processor sends a first verification message to trading center prior to sending the security information; wherein the first verification message is encrypted and can only be read by the trading center; the trading center can reply a second verification message according to the first verification message, the trading processor then activates the dataflow valve for transaction flow as well as stops receiving advertisement information sent from advertisement center, and sends the security information to the trading center; the trading center replies a transaction success message to the transaction processor when the transaction is completed; after the transaction has been completed, the transaction processor then turns on the advertisement flow of the dataflow valve and resumes receiving of advertisement information from the advertisement center.

4. The switching system able to prevent fraud by falsified digital information of claim 3, wherein the transaction processor contains a database, wherein the database contains a plurality of address of trading centers and a plurality of first safety codes; the first safety code is designated for each address of trading center; the first verification message includes one address of trading center and one first safety code; the trading center must confirms the first safety code before accessing the first verification message; the trading center can also send a transaction request message stored first safety code.

5. The switching system able to prevent fraud by falsified digital information of claim 4, can be operated as follow:
(S21) sub-processor processes the advertisement information sent from the advertisement center via the dataflow valve and the advertisement information is displayed on the monitor system;
(S22) the transaction processor determine if a transaction request message sent from the trading center can be accepted, If yes, proceed step (S23), if no, proceed step (S21);
(S23) transaction processor controls the dataflow valve to inactivate the advertisement flow while activating trading flow;
(S24) transaction processor prompts the sub-processor to stop receiving advertisement information sent from the advertisement center, and the transaction request message is displayed on the monitor system;
(S25) transaction processor receives the transaction information from the financial transaction devices;
(S26) the transaction information sent from the financial transaction device is encrypted and processed, then formed a security information by the transaction processor;
(S27) trading center then send transaction success message to the transaction processor;
(S28) transaction processor prompts the sub-processor to receive the advertisement information sent from the advertisement center, and activates the advertisement flow.

6. The switching system able to prevent fraud by falsified digital information of claim 5, the transaction processor verifies the address of the trading center stored in the database and the first verification message with the transaction request message sent from the trading center.

7. The switching system able to prevent fraud by falsified digital information of claim 1, wherein the financial transaction devices may consists of an ICC card reader, a Magstripe reader device, a password entering device or wireless information reader.

8. The switching system able to prevent fraud by falsified digital information of claim 1, wherein the trading center may responds a second verification message to the transaction processor when received the security information from the transaction processor; the transaction processor sent the second verification message to the monitor system, and the second verification message is displayed on the monitor system, the transaction processor then receives and processes the transaction information sent from the financial transaction device, the transaction information is also encrypted and processed to form a security information; the transaction information then is sent to the trading center via the sub-processor; the trading center replies a transaction success message to transaction processor.

9. The switching system able to prevent fraud by falsified digital information of claim 1, wherein the security information must contain a second verification code, and the trading center must verify the second verification code prior to reading the security information when receiving security information.
